(19) United States
(12) Patent Application Publication
(10) Pub. No.: US 2012/0013604 A1
(43) Pub. Date: Jan. 19, 2012

(54) DISPLAY APPARATUS AND METHOD FOR SETTING SENSE OF DEPTH THEREOF

(75) Inventor: Ho-woong KANG, Yongin-si (KR)

(73) Assignee: SAMSUNG ELECTRONICS CO., LTD., Suwon-si (KR)

(21) Appl. No.: 13/012,391

(22) Filed: Jan. 24, 2011

(30) Foreign Application Priority Data
Jul. 14, 2010 (KR) 2010-0067983

(51) Int. Cl. G06T 15/00

(52) U.S. Cl. 345/419

(57) ABSTRACT

A display apparatus is provided. The display apparatus includes a display and an image extractor that extracts a reference object included in an input image, an image converter that calculates a distance from a position on a screen at which the input image is displayed to a virtual position of the reference object when the reference object is expressed as a 3D image. The display apparatus automatically sets a depth corresponding to the distance, and a controller controls the display unit to display the input image as a 3D image according to the set depth.

### CROSS-REFERENCE TO RELATED APPLICATION

This application claims priority from Korean Patent Application No. 10-2010-0067983, filed on Jul. 14, 2010, in the Korean Intellectual Property Office, the disclosure of which is incorporated herein by reference in its entirety.

### BACKGROUND

1. Field

Apparatuses and methods consistent with exemplary embodiments relate to a display apparatus and a method for setting a sense of depth thereof, and more particularly, to a display apparatus which is capable of setting a sense of depth in consideration of a visual difference between both eyes, and a method for setting a sense of depth thereof

2. Description of the Related Art

Thanks to the development of electronic technologies, home appliances such as a television (TV) are rapidly developing. In particular, in the field of TV, a 3-dimensional television (3D TV), which is a new concept television providing liveliness and reality to a viewer by adding depth information to an original 2-dimensional (2D) mono image and making a viewer enjoy stereoscopic image and sound, is rapidly developing.

The 3D TV technology creates additional information with respect to a 2-D image by applying user's both eyes and a stereoscopic vision technology, and makes a viewer feel as if the viewer is in the place where an image is created due to the additional information, thereby providing liveliness and reality.

Currently, many places where events take place such as global expos or exhibitions increasingly use the 3D image technology to the extent that the use of the 3D technology has become essential. Therefore, viewers can enjoy beautiful stereoscopic images in those places. The 3D image can provide a completely different effect from that of the 2D image such that the viewer may stretch the viewer's hands to catch the 3D image in front of the viewer's eyes or avoid an image approaching from the front side.

However, since a related-art 3D TV does not consider various factors when expressing a sense of depth and uniformly reflects a visual difference, the illusion of depth is not realistic and therefore causes dizziness or visual fatigue to the viewers.

### SUMMARY

One or more exemplary embodiments may address the above disadvantages and other disadvantages not described above. However, it is understood that one or more exemplary embodiments are not required to overcome the disadvantages described above, and may not overcome any of the disadvantages described above.

One or more exemplary embodiments provide a display apparatus which calculates a distance to a virtual position when a reference object is expressed as a 3D image and automatically sets a sense of depth, and a method for setting a sense of depth thereof.

According to an aspect of an exemplary embodiment, there is provided a method for setting a sense of depth of a display apparatus. The method may include extracting a reference object included in an input image, calculating a distance from a position on a screen at which the input image is displayed to a virtual position of the reference object when the reference object is expressed as a 3-dimensional (3D) image, automatically setting a depth corresponding to the distance, and displaying the input image as a 3D image according to the set depth.

The calculating the distance may include calculating the distance based on at least one of a viewer's age, a size of the screen, a distance between the screen and a viewer, a distance between the viewer's eyes, and a size of the reference object.

The calculating the distance may include, if a size of the reference object is changed as the reference object is extracted on a real time basis, calculating the distance based on a change in a distance between a viewer and the screen and a change in the size of the reference object.

The method may further include storing a type of the reference object and a standard size of the reference object.

The calculating the distance may include identifying a type of the extracted reference object and a size of the extracted reference object, comparing the identified size with the stored standard size and determining a ratio of the identified size to the stored standard size, and calculating the distance based on a distance between a viewer and the screen of the display apparatus, and the determined ratio.

The setting the depth may include setting the depth automatically by changing a separation distance between a left-eye image and a right-eye image of the input image based on the calculated distance.

The storing may include storing the standard size so that the standard size is in inverse proportion to a size of the screen.

The setting may include setting the depth automatically by changing the separation distance between the left-eye image and the right-eye image of the input image according to a viewer's age or a distance between the viewer's eyes.

The method may further include displaying a screen to input at least one of a viewer's age, a distance between the viewer's eyes, and a distance between the viewer and the screen.

According to an aspect of another exemplary embodiment, there is provided a display apparatus including a display unit, an image extractor that extracts a reference object included in an input image, an image converter that calculates a distance from a position on a screen at which the input image is displayed to a virtual position of the reference object when the reference object is expressed as a 3D image, and automatically sets a depth corresponding to the distance, and a controller that controls the display unit to display the input image as a 3D image according to the set depth.

The image converter may calculate the distance based on at least one of a viewer's age, a size of the screen, a distance between the screen and a viewer, a distance between the viewer's eyes, and a size of the reference object.

If a size of the reference object is changed as the reference object is extracted on a real time basis, the image converter may calculate the distance based on a change in a distance between a viewer and the screen and a change in the size of the reference object.

The display apparatus may further include a storage unit that stores a type of the reference object and a standard size of the reference object.

The image converter may include an identification unit that identifies a type of the extracted reference object and a size of the extracted reference object, a determiner that compares the identified size with the stored standard size and determines a ratio of the identified size to the stored standard size, a calculator that calculates the distance based on a distance between a viewer and the screen of the display apparatus and the determined ratio, and a processor that sets the depth automatically by changing a separation distance between a left-eye image and a right-eye image of the input image based on the calculated distance.

The storage unit may store the standard size so that the standard size is in inverse proportion to a size of the screen.

The processor may set the depth automatically by changing the separation distance between the left-eye image and the right-eye image of the input image according to a viewer's age or a distance between the viewer's eyes.

The display apparatus may further include a user interface that receives at least one of a viewer's age, a distance between the viewer's eyes, and a distance between the viewer and the screen.

Additional aspects and advantages of the exemplary embodiments will be set forth in the detailed description, will be obvious from the detailed description, or may be learned by practicing the exemplary embodiments.

### BRIEF DESCRIPTION OF THE DRAWING

The above and/or other aspects will be more apparent by describing in detail exemplary embodiments, with reference to the accompanying drawings, in which:

FIG. 1 is a block diagram illustrating a display apparatus according to an exemplary embodiment;

FIG. 2 is a block diagram illustrating an image converter of a display apparatus in detail, according to an exemplary embodiment;

FIG. 3 is a view to explain a virtual distance according to an exemplary embodiment;

FIG. 4 is a view to explain a visual difference according to an exemplary embodiment;

FIGS. 5A to 5C are views illustrating an example of a visual difference which is changed according to various conditions;

FIGS. 6A to 6C are views illustrating an example of a method for setting a sense of depth of a display apparatus according to an exemplary embodiment;

FIG. 7 is a flowchart illustrating a method for setting a sense of depth of a display apparatus according to an exemplary embodiment; and

FIG. 8 is a flowchart illustrating a method for setting a sense of depth of a display apparatus according to another exemplary embodiment.

### DETAILED DESCRIPTION OF THE EXEMPLARY EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail. Expressions such as “at least one of,” when preceding a list of elements, modify the entire list of elements and do not modify the individual elements of the list.

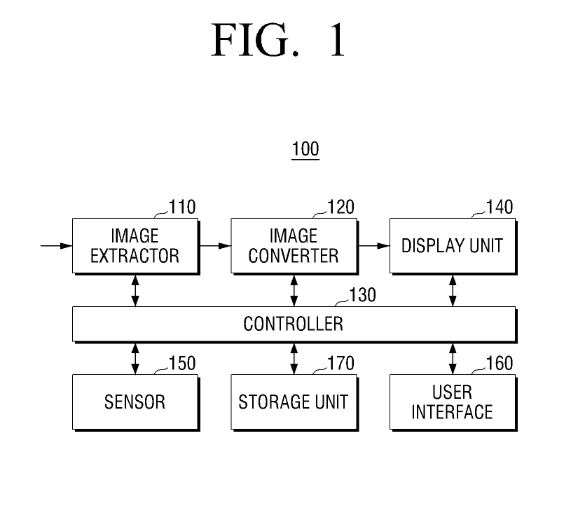

FIG. 1 is a block diagram illustrating a display apparatus 100 according to an exemplary embodiment.

Referring to FIG. 1, the display apparatus 100 includes an image extractor 110, an image converter 120, a controller 130, a display unit 140, a sensor 150, a user interface 160, and a storage unit 170.

The image extractor 110 extracts a reference object included in an input image.

The input image may be an image that is provided from a broadcasting station and received at the display apparatus 100. The input image may be a 2-dimensional (2D) image or a 3-dimensional (3D) image. However, the 3D image may be an image that has a uniform depth.

The reference object is an object the depth of which will be set and may be, but is not limited to, for example, a human face, an apple, a car, a soccer ball, or a baseball bat included in the input image. At least one reference object may be included in the input image provided on a real time basis.

The image extractor 110 may extract the reference object on a real time basis.

The image extractor 110 may recognize at least one reference object from an entire display screen and extract the at least one reference object. The reference object recognizable by the image extractor 110 may be previously stored in the storage unit 170.

For example, if the input image includes a human face, the image extractor 100 determines the shape, skin color, and positions of eyes, nose, and lip of the human face and recognizes that the input image includes the human face and the human face is the reference object. The reference object may be recognized in various methods known in the related art.

The image converter 120 calculates a virtual distance, which is a distance from a screen position at which the input image is displayed to a virtual position at which the reference object is expressed as a 3D image, and automatically sets a depth corresponding to the calculated distance.

Also, the image converter 120 may calculate the virtual distance based on at least one of a viewer's age, a size of a screen of the display apparatus 100, a distance between the screen and a viewer, and a distance between both eyes of the viewer, and a size of the reference object.

Specifically, if the size of the reference object is changed as the reference object is extracted on a real time basis, the image converter 120 may calculate the distance based on a change in the distance between the viewer and the screen and a change in the size of the reference object.

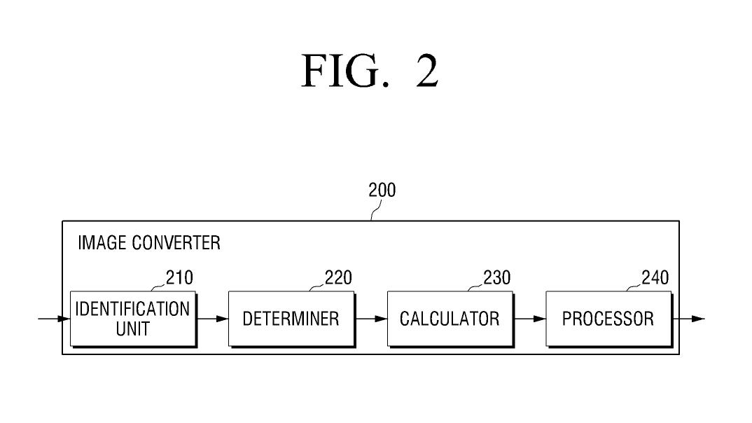

A detailed operation of the image converter 120 will be explained later with reference to FIG. 2.

The controller 130 controls the respective elements 110 to 170 as shown in FIG. 1.

Specifically, the controller 130 controls the display unit 140 to display the input image as a 3D image according to the set depth.

The display unit 140 displays the image.

Also, the display unit 140 may display a menu screen to receive the at least one of the viewer's age, the distance between the viewer's eyes, and the distance between the viewer and the screen.

The sensor 150 senses the distance between the viewer and the screen of the display apparatus 100. The sensor 150 may be provided on an area of the display apparatus 100 and may sense the distance between the viewer and the screen using, for example, an ultrasonic sensor.

Also, the sensor 150 may include a camera module to measure the distance between the viewer's eyes and may capture the distance between the viewer's eyes. In this case, the display apparatus 100 may further include an element for processing and analyzing a captured image.

In addition, the sensor 150 senses a signal transmitted from 3D glasses, such as for example shutter glasses, and checks the type of 3D glasses, thereby identifying the viewer's age. In general, the size of 3D glasses is smaller for younger viewers, and the size of 3D glasses is larger for older viewers. Therefore, a signal having a different format according to the size of the 3D glasses is transmitted from the 3D glasses and the sensor 150 receives the signal of the different format from the 3D glasses, so that the viewer's age may be identified.

The sensor 150 is not limited to the above-described sensor and may sense the viewer's age, the distance between the viewer and the screen, and the distance between the viewer's eyes, in various methods known in the related art.

The user interface 160 receives the at least one of the viewer's age, the distance between the viewer's eyes, and the distance between the viewer and the screen.

As an alternative to the sensor 150 automatically sensing the at least one of the viewer's age, the distance between the viewer's eyes, and the distance between the viewer and the screen, the user interface 160 may provide a menu screen to receive the at least one of the viewer's age, the distance between the viewer's eyes, and the distance between the viewer and the screen.

The user interface 160 may receive the size of the screen of the display apparatus 100. Accordingly, even if the size of the screen of the display apparatus 100 is intentionally changed by the viewer, it is possible to adaptively set a sense of depth in the display apparatus 100.

The storage unit 170 stores a type of the reference object and a standard size of the reference object.

The type of the reference object is information for identifying the reference object, i.e., for identifying what the reference object indicates. For example, the reference object may indicate a human face, an apple, or an air plane. The reference object is classified in various classifying methods and stored in the storage unit 170.

The standard size is a general size of the reference object. For example, the standard size may be an average size of the reference object. The standard size may be defined by various forms such as the number of pixels arranged in a horizontal direction, the number of pixels arranged in a vertical direction, and the number of pixels arranged in a diagonal direction. The standard size is advantageously defined by the number of pixels arranged in the diagonal direction.

If the reference object is a human face, the storage unit 170 may classify an average size of the human face by country, such as into an average size of Korean faces, an average size of British faces, and an average size of American faces, and stores the classified average size of the faces.

The storage unit 170 may store sizes of real images as much as possible and may store a physical size of an object which generally has a fixed size such as a human face, a soccer ball, and a car, as a coefficient.

Also, the storage unit 170 may store the standard size in inverse proportion to the size of the screen of the display apparatus 100. For example, the 52-inch display apparatus 100 stores the standard size of half the standard size of the 26-inch display apparatus 100. This is because the same image input to the display apparatus 100 looks two times larger on the 52-inch display apparatus 100.

The storage unit 170 may store a reference distance between both eyes and a real distance between both eyes. For example, the storage unit 170 may classify the real distance between both eyes with reference to the reference distance between both eyes. For example, if the reference distance between both eyes is 6.5 cm, the real distance is classified into a ‘distance shorter than 6.5 cm by 10%’ and ‘a distance longer than 6.5 cm by 10%’. The storage unit 170 may store a coefficient indicating a ratio of the real distance to the reference distance between both eyes.

The storage unit 170 may store the size of the display apparatus 100 and may store the standard sizes corresponding to the various sizes of the display apparatus 100. For example, the standard size of the 52-inch display apparatus 100 and the standard size of the 26-inch display apparatus may be stored. Accordingly, even if the size of the screen is intentionally changed by the user, the sense of depth can be set adaptively according to a user's preference.

The storage unit 170 may store a type of language displayed.

In the display apparatus 100 according to an exemplary embodiment, the sense of depth is set individually for each reference object based on the size of the reference object so that the reality of the input image can be further highlighted. Accordingly, in comparison to a related-art display apparatus in which a sense of depth is uniformly set, the display apparatus 100 according to an exemplary embodiment can mitigate visual fatigue and dizziness.

The display apparatus 100 may be a television (TV). However, the display apparatus 100 may display an image signal in which a sense of depth is set after the functions of the elements 110, 120, 130, 150, 160, 170 shown in FIG. 1 are performed in a set-top box (not shown).

FIG. 2 is a block diagram illustrating an image converter 200 of a display apparatus in detail, according to an exemplary embodiment.

Referring to FIG. 2, the image converter 200 includes an identification unit 210, a determiner 220, a calculator 230, and a processor 240.

The identification unit 210 identifies the type of an extracted reference object and the size of the extracted reference object.

The determiner 220 compares the identified size with the stored standard size and determines a ratio of the identified size to the stored standard size.

For example, if the type of the reference object is a human face, the display apparatus 100 determines whether a Korean language is used (displayed) in the display apparatus 100 or not. If it is determined that the Korean language is used, the storage unit 170 compares the size of the face of the reference object in the input image with the average size of the Korean face stored therein.

The calculator 230 calculates the virtual distance based on the distance between the viewer and the screen of the display apparatus 100 and the determined ratio.

The processor 240 changes a separation distance between a left-eye image and a right-eye image of the input image based on the calculated virtual distance, thereby setting a depth automatically.

The processor 240 may change the separation distance between the left-eye image and the right-eye image by changing a position of one of the left-eye image and the right-eye image. Alternatively, the processor 240 may change the separation distance between the left-eye image and the right-eye image by changing the positions of both of the left-eye image and the right-eye image.

Also, the processor 240 may change the separation distance between the left-eye image and the right-eye image according to the viewer's age or the distance between the viewer's eyes, thereby setting the depth automatically.

Although the image converter 200 of FIG. 2 is given a different reference numeral from that of the image converter 120 of FIG. 1, the image converter 200 may be the image converter 120 of FIG. 1. Also, each element 210 to 240 of the image converter 200 may be controlled by the controller 130 to perform the above-described operations. In addition, the image converter 120, 200 may be realized using software or hardware, and if the image converter 120, 200 is realized using hardware, the image converter 120, 200 may be a single chip such as an Application Specific Integrated Circuit (ASIC).

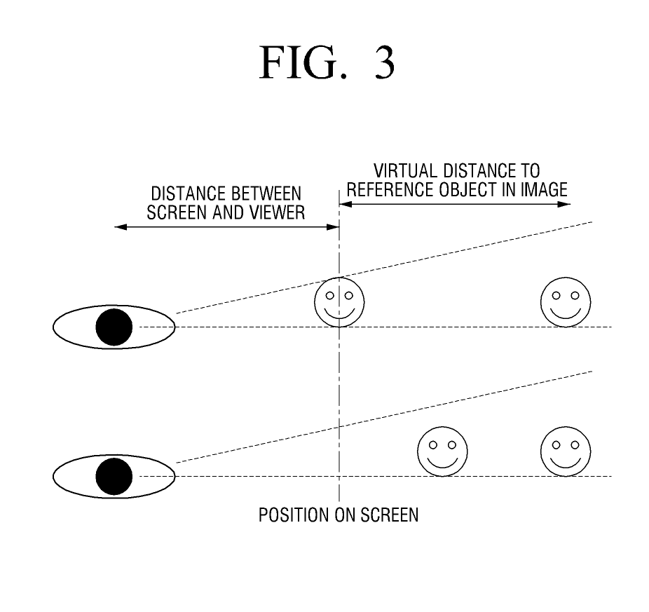

FIG. 3 is a view to explain the virtual distance.

Referring to FIG. 3, if a face of a real size (that is, the reference object) is displayed on the screen of the display apparatus 100 as shown in the upper portion of FIG. 3, the virtual distance of the input image is determined according to the size of another face which is smaller. For example, as shown in the lower portion of FIG. 3, if the face is displayed to be of half the size of the reference object, a small face at the same distance as the distance between the viewer and the screen has illusion of depth, and a visual difference provided to the two eyes may be determined in proportion to the virtual distance, that is, a sense of depth.

According to an exemplary embodiment, if the virtual distance from the reference object is adjusted, the reference object looks as if the reference object is close to the viewer or as if the reference object is far from the viewer.

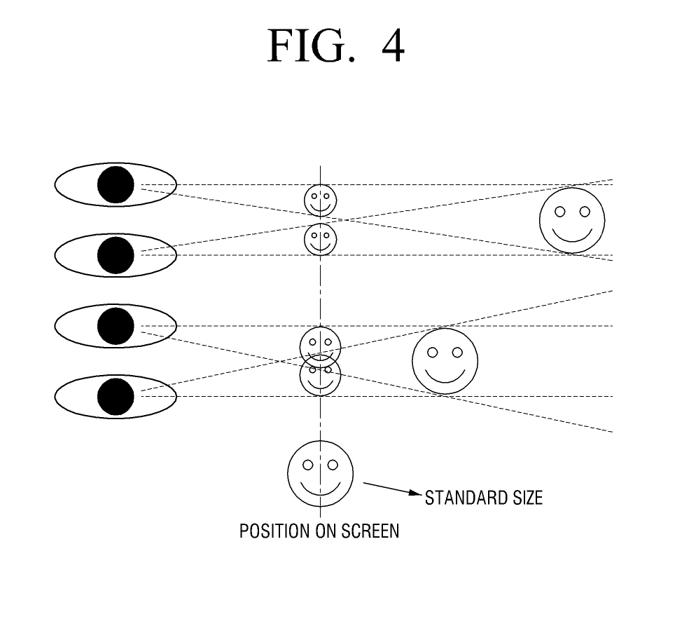

FIG. 4 is a view to explain the visual difference according to an exemplary embodiment.

Referring to FIG. 4, a visual difference with respect to a distant object is greater than a visual difference with respect to a close object, and the virtual distance is different according to the visual difference between images provided to the left-eye and the right eye.

The visual difference recited herein refers to a separation distance between a left-eye image and a right-eye image. The separation distance between the left-eye image and the right-eye image illustrated on the upper portion of FIG. 4 is relatively greater than the separation distance between the left-eye image and the right-eye image illustrated on the lower portion of FIG. 4.

For example, if the reference object displayed on the screen looks smaller than the real size (standard size), the virtual distance becomes longer. In other words, the distance between the viewer and the screen becomes longer and thus the visual difference between the left-eye image and the right-eye image also becomes greater.

As described above, by detecting how much the reference object is changed in size in comparison with the real size (standard size) and determining the visual difference between the left-eye image and the right-eye image based on the result of detection, a realistic physical distance can be expressed.

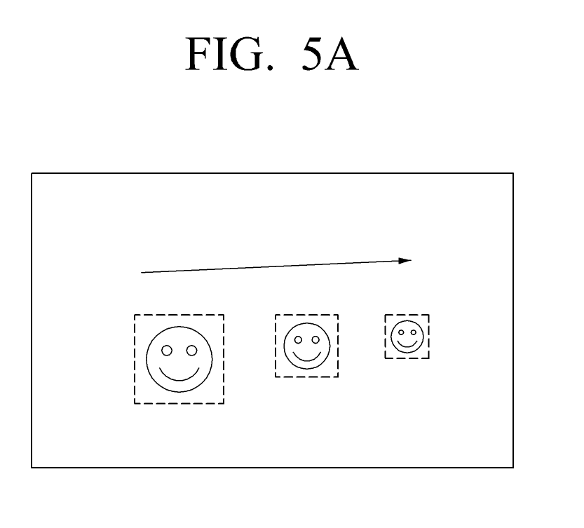

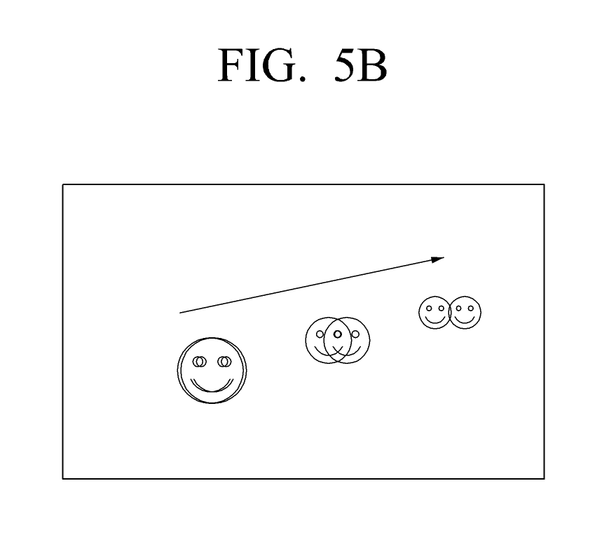

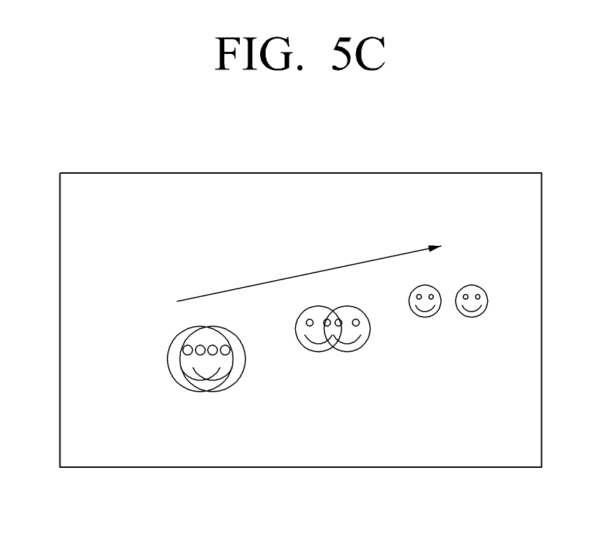

FIGS. 5A to 5C are views illustrating an example of the visual difference which is changed according to various conditions.

After calculating the virtual distance, the display apparatus 100 may consider at least one of the viewer's age, the size of the screen, the distance between the screen and the viewer, the distance between the viewer's eyes, and the size of the reference object, in order to obtain a desirable visual difference by controlling the separation distance between the left-eye image and the right-eye image.

Referring to FIG. 5A, the visual difference may be changed according to the size of the screen. The size of the screen is smaller as the arrow advances.

The real size (standard size) of the reference object displayed on the screen may be determined according to the size of the screen. The same image may be displayed to be different between the 32-inch display apparatus 100 and the 46-inch display apparatus 100. Therefore, since the same image is displayed to be small on the 32-inch display apparatus 100, the separation distance between the left-eye image and the right-eye image is changed to be longer in the 32-inch display apparatus 100 in order to increase the virtual distance.

Referring to FIG. 5B, the visual difference may be changed according to the distance between the viewer and the screen. The distance between the viewer and the screen is longer as the arrow advances.

If the distance between the viewer and the screen is increased, the visual difference between the left-eye image and the right-eye image is changed to be longer.

However, if the size of the reference object corresponds to the real size (standard size), there is no separation distance between the left-eye image and the right-eye image and thus there is no visual difference. Therefore, even if the distance between the viewer and the screen is increased, there is no change in the visual difference.

Referring to FIG. 5C, the visual difference may be changed according to the viewer's age or the distance between the viewer's eyes. The viewer's age increases as the arrow advances.

Assuming the distance between adult's eyes is 6.5 cm, the distance between a kid's eyes will be shorter than 6.5. Since it is general that the distance between the adult's eyes is 6.5 cm, the virtual distance is different according to the viewer's age.

Since a younger viewer such as a kid has a smaller distance between both eyes, an adult is recognized as being more distant from the screen.

Accordingly, in the case of an adult, the visual difference between the left-eye image and the right-eye image is changed to be greater than the visual difference of the kid.

Also, since the kid may have a relatively great distance between both eyes and the adult may have a relatively small distance between both eyes, it is advantageous to change the visual angle according to the distance between the eyes.

The various conditions described in FIGS. 5A to 5C may be individually considered. However, an optimal sense of depth may be set when the conditions are collectively considered.

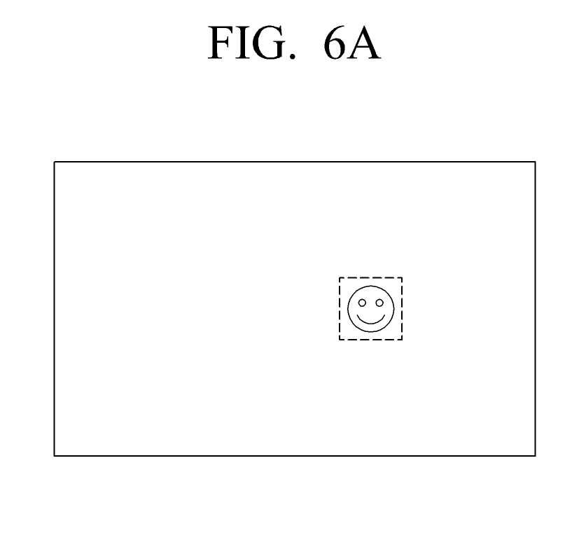

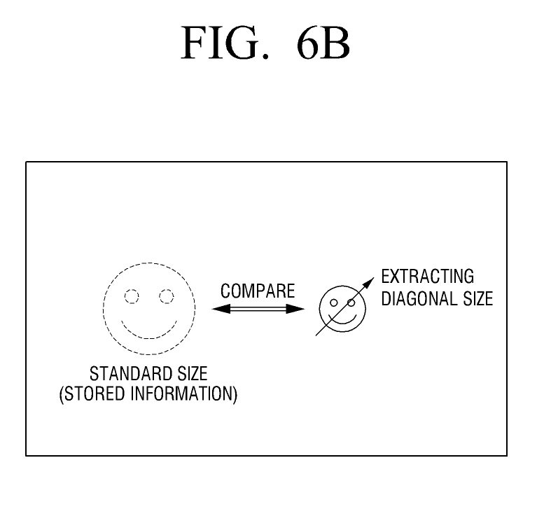

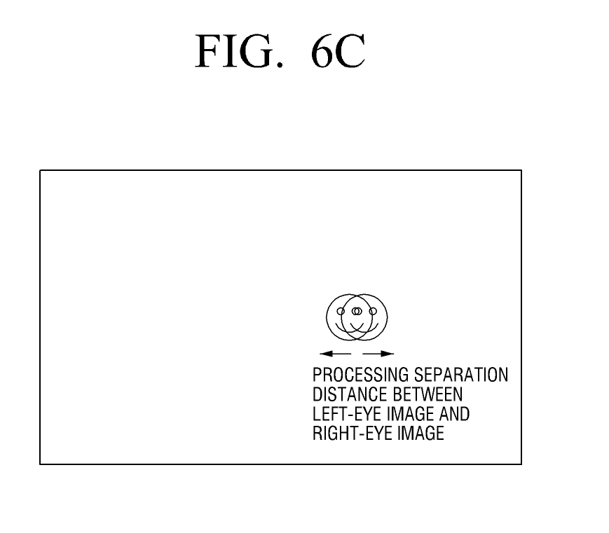

FIGS. 6A to 6C illustrate an example of a method for setting a sense of depth in a display apparatus according to an exemplary embodiment.

Referring to FIG. 6A, the image extractor 110 extracts the reference object displayed on the screen.

Although one reference object is displayed on the screen for convenience of explanation, a plurality of reference objects may be displayed on the screen.

Referring to FIG. 6B, the identification unit 210 identifies the type of the extracted reference object and the size of the extracted reference object.

The identification unit 210 identifies that the type of the reference object is a human face and identifies that the size of the reference object is 125 pixels using the number of pixels arranged in the in the diagonal direction.

After that, the determination unit 220 determines the ratio of the size of the reference object to the standard size, using information regarding the various types of the object and the standard size which are stored in the storage unit 170.

In this case, the determination unit 220 may determine the ratio of the size of the reference object to the standard size by classifying the size of the extracted image into various ratios, such as 1.0 if the size of the reference object is equal to the standard size, 1.1 if the size of the reference object is larger than the standard size by 10%, and 0.9 if the size of the reference object is smaller than the standard size by 10%.

For example, if the standard size of the human face stored in the storage unit 170 is 250 pixels, the determination unit 220 compares the human face of the input image with the standard size of the human face and determines the ratio of the size of the reference object to the standard size as 0.5.

The calculator 230 calculates the virtual distance based on the distance between the viewer and the screen, which may be sensed by the sensor 150 or may be input through the user interface 160, and the ratio determined by the determiner 220.

For example, if the distance between the viewer and the screen is 5 m and the determined ratio is 0.5, the calculator 230 calculates the virtual distance of 5 m.

Referring to FIG. 6C, the processor 240 changes the separation distance between the left-eye image and the right-eye image of the input image based on the calculated virtual distance, thereby setting the depth automatically.

In FIGS. 6A and 6C, the sense of depth in the display apparatus 100 is set by changing the separation distance based on the distance between the viewer and the screen and the ratio of the size of the reference object to the standard size. However, the sense of depth may be set taking into consideration the viewer's age, the size of the screen, and the distance between viewer's eyes, collectively.

For example, the distance between viewer's eyes or the viewer's age may be additionally considered for the determined sense of depth in FIG. 6C. If the distance between the viewer's eyes is 6.5 cm, the separation distance is retained, and, if the distance between the viewer's eyes is smaller than 6.5 cm, the separation distance is reduced according to a predetermined ratio. The predetermined ratio may be a ratio of a real distance between both eyes to the reference distance of 6.5 cm.

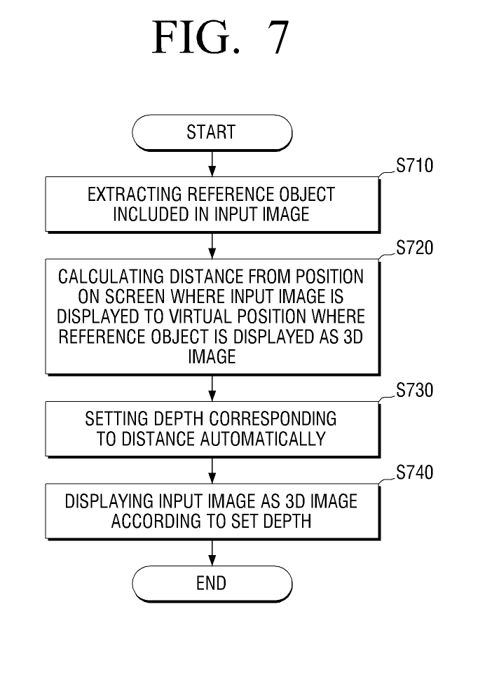

FIG. 7 is a flowchart illustrating a method for setting a sense of depth of a display apparatus according to an exemplary embodiment. Referring to FIG. 7, according to the method for setting the sense of depth of the display apparatus according to an exemplary embodiment, the extractor 110 extracts a reference object included in an input image (S710).

The image converter 120 calculates a distance from a position on the screen at which the input image is displayed to a virtual position at which the reference object is expressed as a 3D image (S720).

The image converter 120 automatically sets a depth corresponding to the distance (S730).

The display unit 130 displays the input image as the 3D image according to the set depth (S740).

A repeated explanation of some features described in more detail above is omitted here.

According to the method for setting the sense of depth of the display apparatus according to an exemplary embodiment, the 3D image is displayed in consideration of at least one of the viewer's age, the size of the screen, the distance between the viewer and the display apparatus, and the distance between the viewer's eyes, so that the sense of depth in the 3D image is automatically determined. Also, the viewer can sense liveliness when viewing the 3D image and thus the dizziness or visual fatigue can be prevented.

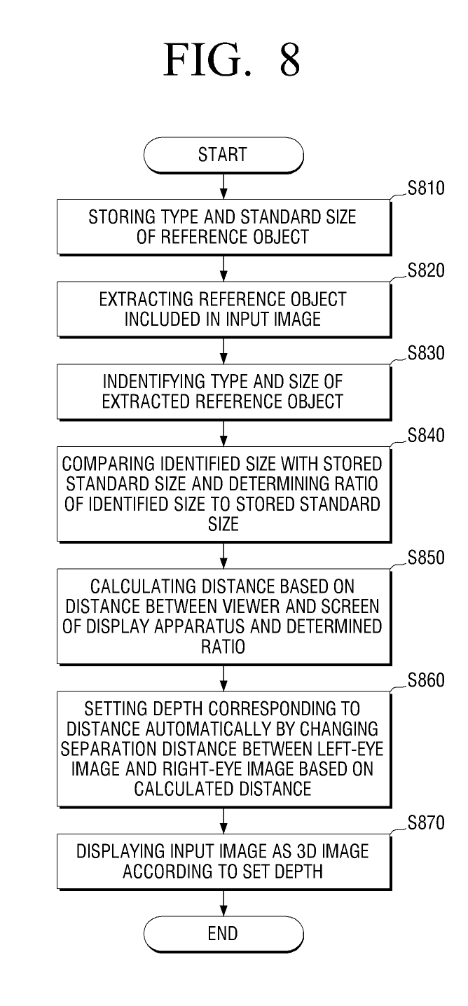

FIG. 8 is a flowchart illustrating a method for setting a sense of depth of a display apparatus according to another exemplary embodiment.

Referring to FIG. 8, according to the method for setting the sense of depth of the display apparatus according to another exemplary embodiment, the storage unit 170 stores a type of a reference object and a standard size of the reference object (S810).

The image extractor 110 extracts a reference object included in an input image (S 820).

The identification unit 210 identifies a type and a size of the extracted reference object (S830).

The determiner 220 compares the identified size with the stored standard size and determines a ratio of the identified size to the standard size (S840).

The calculator 230 calculates a distance based on the distance between the viewer and the display apparatus 100 and the determined ratio (S850).

The calculator 240 changes a separation distance between a left-eye image and a right-eye image of the input image based on the calculated distance, thereby setting a depth automatically (S860).

The display unit 140 displays the input image as a 3D image according to the set depth (S870).

According to the method for setting the sense of depth of the display apparatus according to another exemplary embodiment, the reality is reflected by setting the sense of depth differently according to the reference object, so that the dizziness or visual fatigue can be mitigated.

A repeated explanation of some features described in more detail above is omitted here.

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method for setting a sense of depth of a display apparatus, the method comprising:
extracting a reference object included in an input image;
calculating a distance from a position on a screen at which the input image is displayed to a virtual position of the reference object when the reference object is expressed as a 3-dimensional (3D) image;
automatically setting a depth corresponding to the distance; and
displaying the input image as a 3D image according to the set depth.

2. The method as claimed in claim 1, wherein the calculating the distance comprises calculating the distance based on at least one of a viewer's age, a size of the screen, a distance between the screen and a viewer, a distance between the viewer's eyes, and a size of the reference object.

3. The method as claimed in claim 1, wherein the calculating the distance comprises, if a size of the reference object is changed as the reference object is extracted on a real time basis, calculating the distance based on a change in a distance between a viewer and the screen, and a change in the size of the reference object.

4. The method as claimed in claim 1, further comprising storing a type of the reference object and a standard size of the reference object.

5. The method as claimed in claim 4, wherein the calculating the distance comprises:
identifying a type of the extracted reference object and a size of the extracted reference object;
comparing the identified size with the stored standard size and determining a ratio of the identified size to the stored standard size; and
calculating the distance based on a distance between a viewer and the screen of the display apparatus, and the determined ratio.

6. The method as claimed in claim 5, wherein the setting the depth comprises setting the depth automatically by changing a separation distance between a left-eye image and a right-eye image of the input image based on the calculated distance.

7. The method as claimed in claim 4, wherein the storing the standard size comprises storing the standard size so that the standard size is in inverse proportion to a size of the screen.

8. The method as claimed in claim 6, wherein the setting comprises setting the depth automatically by changing the separation distance between the left-eye image and the right-eye image of the input image according to a viewer's age or a distance between the viewer's eyes.

9. The method as claimed in claim 1, further comprising displaying a screen to input at least one of a viewer's age, a distance between the viewer's eyes, and a distance between the viewer and the screen.

10. A display apparatus comprising:
a display unit;
an image extractor that extracts a reference object included in an input image;
an image converter that calculates a distance from a position on a screen at which the input image is displayed to a virtual position of the reference object when the reference object is expressed as a 3D image, and automatically sets a depth corresponding to the distance; and
a controller that controls the display unit to display the input image as a 3D image according to the set depth.

11. The display apparatus as claimed in claim 10, wherein the image converter calculates the distance based on at least one of a viewer's age, a size of the screen, a distance between the screen and a viewer, a distance between the viewer's eyes, and a size of the reference object.

12. The display apparatus as claimed in claim 10, wherein, if a size of the reference object is changed as the reference object is extracted on a real time basis, the image converter calculates the distance based on a change in a distance between a viewer and the screen, and a change in the size of the reference object.

13. The display apparatus as claimed in claim 10, further comprising a storage unit that stores a type of the reference object and a standard size of the reference object.

14. The display apparatus as claimed in claim 13, wherein the image converter comprises:
an identification unit that identifies a type of the extracted reference object and a size of the extracted reference object;
a determiner that compares the identified size with the stored standard size and determines a ratio of the identified size to the stored standard size;
a calculator that calculates the distance based on a distance between a viewer and the screen of the display apparatus, and the determined ratio; and
a processor that sets the depth automatically by changing a separation distance between a left-eye image and a right-eye image of the input image based on the calculated distance.

15. The display apparatus as claimed in claim 13, wherein the storage unit stores the standard size so that the standard size is in inverse proportion to a size of the screen.

16. The display apparatus as claimed in claim 14, wherein the processor sets the depth automatically by changing the separation distance between the left-eye image and the right-eye image of the input image according to a viewer's age or a distance between viewer's eyes.

17. The display apparatus as claimed in claim 10, further comprising a user interface that receives at least one of a viewer's age, a distance between the viewer's eyes, and a distance between the viewer and the screen.

18. The method as claimed in claim 1, wherein the calculating the distance comprises calculating the distance based on a viewer's age, a size of the screen, a distance between the screen and a viewer, a distance between the viewer's eyes, and a size of the reference object.

19. The method as claimed in claim 1, wherein the reference object is a human face, an apple, a car, a soccer ball, or a baseball bat.
